(19) United States
(12) Patent Application Publication
(10) Pub. No.: US 2017/0353623 A1
(43) Pub. Date: Dec. 7, 2017

(54) IMAGE READING APPARATUS, METHOD OF CONTROLLING IMAGE READING APPARATUS, AND PROGRAM

(71) Applicant: CANON KABUSHIKI KAISHA, Tokyo (JP)

(72) Inventors: Kenji Ono, Abiko-shi (JP); Kazunori Togashi, Toride-shi (JP)

(21) Appl. No.: 15/608,638

(22) Filed: May 30, 2017

(30) Foreign Application Priority Data
Jun. 7, 2016 (JP) 2016-113345

(51) Int. Cl. H04N 1/409; H04N 1/028; H04N 1/00

(52) U.S. Cl. CPC H04N 1/4092; H04N 1/00798; H04N 1/02815; H04N 1/00037; H04N 1/0057; H04N 2201/0081

(57) ABSTRACT

Provided is an image reading apparatus, including: a reader comprising a light source upstream of an image reading position and a light source downstream of the image reading position in a moving direction, each light sources sequentially irradiating an original with light of different colors, the reader reading an original image at the image reading position while moving each light sources relatively to the original in the moving direction; a controller controlling the reading of the original image by the reader by setting a light amount ratio of the light source arranged on the upstream side to the light source arranged on the downstream side for a particular color of the different colors to be different from a light amount ratio for another color; and a detector detecting an image pattern of the particular color depending on the light amount ratio from the original image read by the reader.

### BACKGROUND OF THE INVENTION

### Field of the Invention

The present invention relates to an image reading apparatus, which is configured to read an original image, a method of controlling the image reading apparatus, and a program.

### Description of the Related Art

An original image reading apparatus, which is mounted in a copying machine or a multi-function printer (MFP), is configured to read an image by irradiating an original, which is placed on an original table glass, by a light source and photoelectrically converting reflected light by a reading element.

When originals are placed on the original table glass in a state in which, under an original, another thick original, for example, a business card, is overlaid, a shadow may be generated in an original reading operation in some cases because an end portion of the thick original is not irradiated with light from the light source, or because light reaching the end portion of the thick original is weakened. This shadow portion is read as a black or halftone streak in an image, and hence causes image degradation.

In order to solve the image degradation, in Japanese Patent Application Laid-Open No. H10-285377, a position of an edge and an inclination of the edge of a shadow portion in an image, which is read by a monochrome line sensor, are detected from the image. Then, line symmetry of the inclination is compared, and when the inclination is asymmetry, the shadow portion is determined as a shadow. Further, there is proposed a technology of performing image processing for erasing the determined shadow portion or the shadow portion and several surrounding pixels.

In the method of detecting the edge to detect the inclination from the read-image, when an original image is similar to an image pattern (for example, shadowed letter style or shadowed figure), which is recognized as a shadow, an original image area that is not a shadow may be erroneously recognized as a shadow. In the case of the erroneous recognition, originally unnecessary correction and other such processing are performed, and may contrarily lead to image degradation.

### SUMMARY OF THE INVENTION

The present invention has been made in order to solve the above-mentioned problems. It is an object of the present invention to detect, based on image data of an original, a shadow generated in an end portion of the original with high accuracy.

According to one embodiment of the present invention, there is provided an image reading apparatus, including: a reader comprising a light source arranged on an upstream side of an image reading position in a moving direction and a light source arranged on a downstream side of the image reading position in the moving direction, each of the light sources configured to sequentially irradiate an original with light of different colors, the reader configured to read an original image at the image reading position while moving each of the light sources relatively to the original in the moving direction; a controller configured to control the reading of the original image by the reader by setting a light amount ratio of the light source arranged on the upstream side to the light source arranged on the downstream side for a particular color of the different colors to be different from a light amount ratio for another color; and a detector configured to detect an image pattern of the particular color depending on the light amount ratio from the original image read by the reader.

According to the present invention, based on the image data of the original, the shadow generated in the end portion of the original can be detected with high accuracy.

Further features of the present invention will become apparent from the following description of exemplary embodiments with reference to the attached drawings.

### BRIEF DESCRIPTION OF THE DRAWINGS

FIG. 1 is a cross-sectional view of an image reading apparatus according to a first embodiment of the present invention.

FIG. 2 is a view for illustrating a case where the image reading apparatus according to the first embodiment reads a thick original.

FIG. 3 is a block diagram for illustrating an example of a control configuration of the image reading apparatus according to the first embodiment.

FIG. 4 illustrates an example of a distribution of light amount ratios of an upstream light source to a downstream light source of the image reading apparatus according to the first embodiment for respective colors with respect to a main scanning position.

FIG. 5 is a timing chart for illustrating an example of a CIS line synchronization signal and timings to light the light sources of the image reading apparatus according to the first embodiment.

FIG. 6 illustrates an example of read luminance values of a read original image in the case where the thick original is read by the image reading apparatus according to the first embodiment.

FIG. 7 is a flow chart for illustrating an example of shadow detection operation control in the first embodiment.

### DESCRIPTION OF THE EMBODIMENTS

Now, embodiments of the present invention are described with reference to the drawings.

### First Embodiment

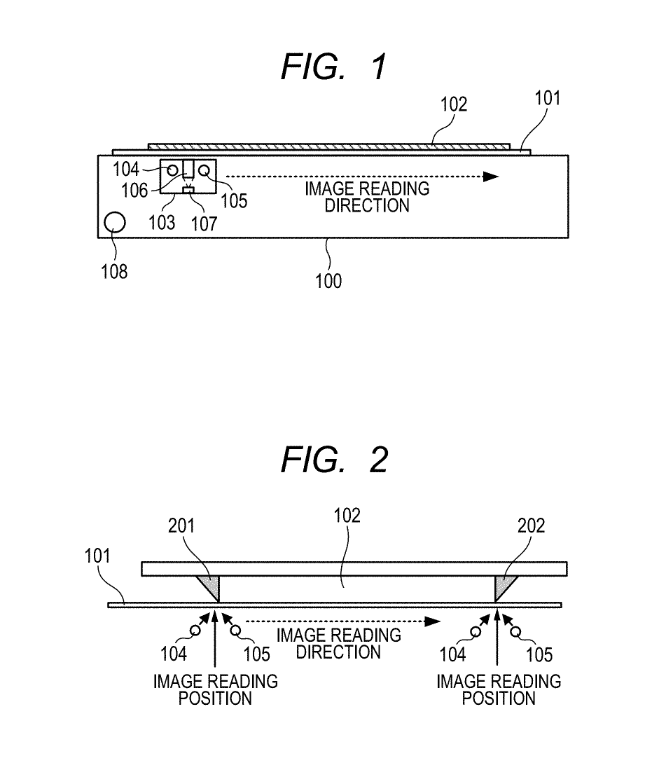

FIG. 1 is a cross-sectional view for illustrating an example of the structure of an image reading apparatus according to a first embodiment of the present invention. In FIG. 1, an image reading apparatus 100 includes an image reader, which is configured to perform image reading on an original 102, which is placed on an original table glass 101, using a both sides lighting CIS 103. The CIS means “contact image sensor”. The both sides lighting CIS 103 includes an upstream light source 104, a downstream light source 105, a lens array 106, and a sensor 107. Each of the upstream light source 104 and the downstream light source 105 emits light of colors of red, green, and blue. Moreover, in the both sides lighting CIS 103, the upstream light source 104 is arranged on an upstream side of an image reading position in an image reading direction (sub-scanning direction, that is, moving direction of the both sides lighting CIS 103), and the downstream light source 105 is arranged on a downstream side of the image reading position in the image reading direction. The sub-scanning direction is a direction in which the CIS 103 moves while the CIS 103 is reading the original 102 placed on the original table glass 101.

A user places the original 102 on the original table glass 101, and gives an instruction to start the image reading. Then, the image reading apparatus 100 causes each of the upstream light source 104 and the downstream light source 105 of the both sides lighting CIS 103 to sequentially emit red, green, and blue light to irradiate the original 102. Then, reflected light from the original 102 is guided to the sensor 107 through the lens array 106, and an original image is read. The image reading apparatus 100 transfers drive of an optical motor 108 to the both sides lighting CIS 103 (unit configured to transfer the drive is not shown). The both sides lighting CIS 103 is conveyed from a leading end to a tail end of the original 102 in the sub-scanning direction to read the entire original image.

FIG. 2 is a view for illustrating a case where the image reading apparatus 100 reads a thick original. When reading of an original is started, and the upstream light source 104 and the downstream light source 105 of the both sides lighting CIS 103 irradiate an upstream end portion of a thick original 102, a shadow 201 is generated in the upstream end portion. This shadow 201 is read as a read-image. When the image reading proceeds, and the upstream light source 104 and the downstream light source 105 irradiate a downstream end portion of the thick original 102, a shadow 202 is generated in the downstream end portion. This shadow 202 is read as the read-image.

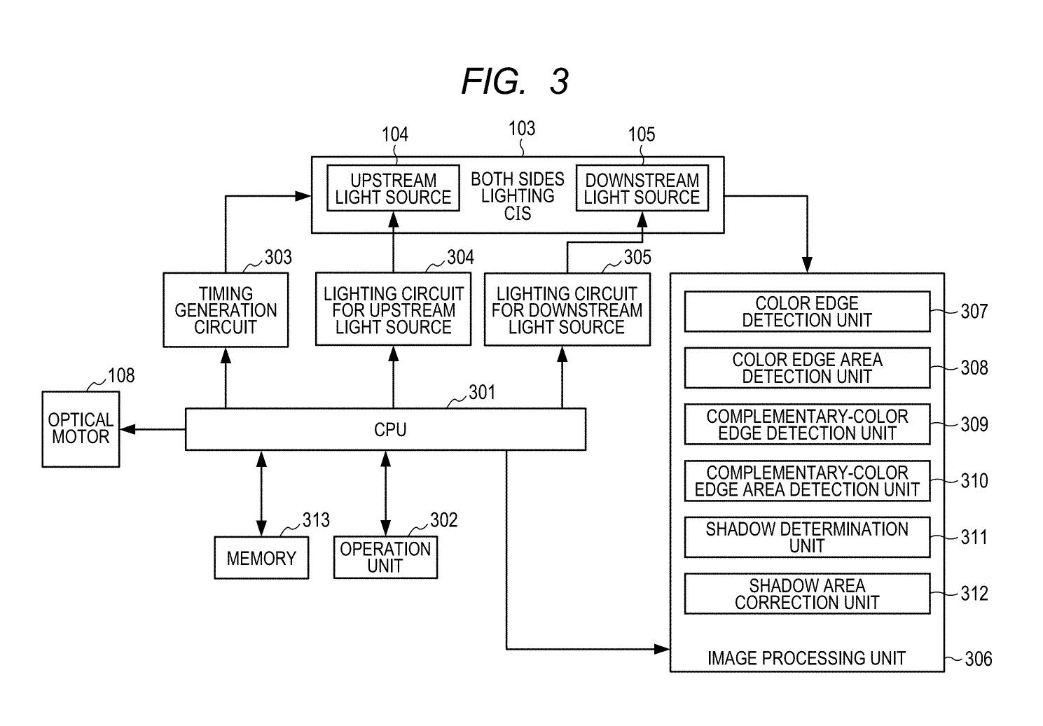

FIG. 3 is a block diagram for illustrating an example of a control configuration of the image reading apparatus 100. In FIG. 3, a central processing unit (CPU) 301 (controller) reads and executes a program stored in a memory 313 to control the entire image reading apparatus 100. The memory 313 includes a flash read-only memory (ROM) or a random access memory (RAM).

For example, when the user performs an operation of starting scanning via an operation unit 302, the CPU 301 starts original image reading processing, and controls a timing generation circuit 303 to output a CIS line synchronization signal (see FIG. 5 for details) to the both sides lighting CIS 103. Subsequently, the CPU 301 controls a lighting circuit 304 for upstream light source, and outputs upstream light source lighting signals (see FIG. 5 for details) to light the upstream light source 104. Similarly, the CPU 301 controls a lighting circuit 305 for downstream light source, and outputs downstream light source lighting signals (see FIG. 5 for details) to light the downstream light source 105. Further, the CPU 301 controls the optical motor 108, and performs an original image reading operation while conveying the both sides lighting CIS 103 from the leading end to the tail end of the original 102. The CPU 301 performs control so as to transmit, as an image signal to an image processing unit 306, image data of the original read by the both sides lighting CIS 103. Then, the CPU 301 controls the image processing unit 306 to perform shadow detection and correction of a shadow area.

The shadow detection and the correction of the shadow area performed by the image processing unit 306 are described. The image processing unit 306 includes detectors 307 to 310, a determinator 311, and a corrector 312. A color edge detection unit 307 is configured to detect a color edge (Edge 1) of a specified color (particular color). Moreover, a color edge area detection unit 308 is configured to detect and store an image area in which the color edge of the particular color is detected. Further, a complementary-color edge detection unit 309 is configured to detect a color edge (Edge 2) of a complementary color of the particular color. For example, when the particular color is green, the complementary color of the particular color is magenta. Moreover, a complementary-color edge area detection unit 310 is configured to detect and store an image area in which a complementary-color edge is detected. Subsequently, a shadow determination unit 311 is configured to determine whether a color edge area and a complementary-color edge area are shadows generated in an edge portion of the original. Further, a shadow area correction unit 312 is configured to correct a shadow portion when the color edge area and the complementary-color edge area are determined as the shadows. The image processing unit is realized by at least one processor, for example, an application specific integrated circuit (ASIC), a system-on-a-chip (SOC), or a central processing unit (CPU).

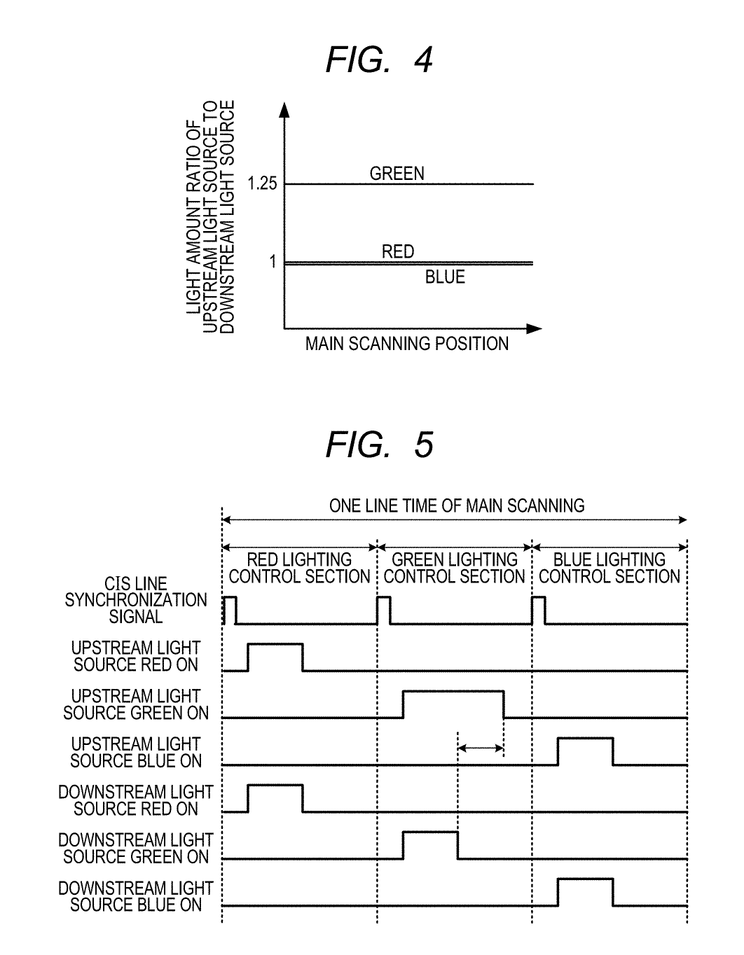

FIG. 4 illustrates an example of a distribution of light amount ratios of the upstream light source 104 to the downstream light source 105 for respective colors of red, green, and blue with respect to a main scanning position in the first embodiment. The image reading apparatus 100 according to the first embodiment has a feature that a light amount ratio of the upstream light source 104 to the downstream light source 105 for the particular color is different from those for the other colors. In the first embodiment, as an example, there is exemplified a case where the particular color is green, and where a light amount ratio is set so that the upstream light source 104 has a light amount that is larger than that of the downstream light source 105 for only green.

The CPU 301 controls the lighting circuit 304 for upstream light source and the lighting circuit 305 for downstream light source to make a setting so that the upstream light source 104 has a green light amount that is 25% larger than that of the downstream light source 105. In other words, the CPU 301 makes the setting so that a ratio of the light amount of the upstream light source 104 to the light amount of the downstream light source 105 to 1.25. The CPU 301 makes settings for red and blue so that a light amount ratio is 1, that is, light amounts of the upstream light source 104 and the downstream light source 105 are the same.

FIG. 5 is a timing chart for illustrating an example of the CIS line synchronization signal, which is output by the timing generation circuit 303 under the control of the CPU 301, and timings to light the light sources. ON signals for red, green, and blue light sources of each of the upstream light source 104 and the downstream light source 105 are hereinafter represented by Upstream_light_source_Red_on, Upstream_light_source_Green_on, Upstream_light_source_Blue_on, Downstream_light_source_Red_on, Downstream_light_source_Green_on, and Downstream_light_source_Blue_on, respectively. For example, when Upstream_light_source_Red_on=High, the red light source of the upstream light source 104 is in a lit state. When Upstream_light_source_Red_on=Low, the red light source of the upstream light source 104 is in an extinguished state. The image reading apparatus 100 controls the six control signals independently under the control of the CPU 301 to control lighting of the respective light sources.

First, the timing generation circuit 303 sets, in a red lighting control section, Upstream_light_source_Red_on and Downstream_light_source_Red_on High for a predetermined period of time to light the red light sources of the upstream light source 104 and the downstream light source 105. Subsequently, the timing generation circuit 303 sets, in the next green lighting control section, Upstream_light_source_Green_on and Downstream_light_source_Green_on High for a predetermined period of time to light the green light sources of the upstream light source 104 and the downstream light source 105. Further, the timing generation circuit 303 sets, in the next blue lighting control section, Upstream_light_source_Blue_on and Downstream_light_source_Blue_on High for a predetermined period of time to light the blue light sources of the upstream light source 104 and the downstream light source 105. The image reading apparatus 100 lights each of the upstream light source 104 and the downstream light source 105 in order of red, green, and blue to irradiate the original, and thus reads a color image of a front side of the original.

As illustrated in FIG. 5, the CPU 301 lights Upstream_light_source_Green_on longer than Downstream_light_source_Green_on. In other words, the CPU 301 performs control so that the green light amount of the upstream light source 104 is set to be larger than the green light amount of the downstream light source 105 to perform the image reading. In other words, the image reading apparatus 100 according to the first embodiment controls the light amount ratio for the particular color (in this example, green) of the plurality of light sources to be different from the light amount ratios for the other colors (in this case, red and blue) to read the original image. In the first embodiment, a total of the green light amount of the upstream light source 104 and the green light amount of the downstream light source 105 is kept unchanged, and the ratio of the green light amount of the upstream light source 104 to the green light amount of the downstream light source 105 is changed. As a result, RGB color balance is maintained in a portion in which a read surface is planar, and a shadow of the particular color or the complementary color of the particular color is generated in a portion like an end portion.

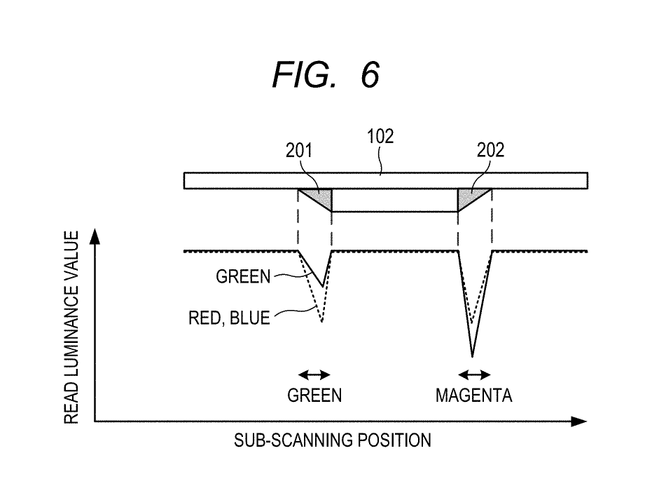

FIG. 6 illustrates an example of read luminance values of a read original image in a case where the thick original 102 is read under a state in which the green light amount of the upstream light source 104 is set to be larger than that of the downstream light source 105.

The shadow 201 generated in the upstream end portion of the thick original 102 in the sub-scanning direction is read as having a green luminance value (indicated by the solid line in FIG. 6) that is larger than red and blue luminance values (indicated by the broken line in FIG. 6). Therefore, the shadow 201 in the upstream end portion is read as being colored in green as compared to a background color.

Contrary to the shadow 201 in the upstream end portion, the shadow 202 generated in the downstream end portion of the thick original 102 in the sub-scanning direction is read as having a green luminance value that is smaller than red and blue luminance values. Therefore, the shadow 202 in the downstream end portion is read as being colored in magenta as compared to the background color.

In other words, the upstream end portion of the original 102 is strongly irradiated with green irradiation light of the upstream light source 104, and hence becomes an edge (hereinafter referred to as “Edge 1”) colored in green. For the downstream end portion, the green irradiation light of the upstream light source 104 is partially blocked by thickness of the end portion of the original. Therefore, the downstream end portion has a read green luminance value that is small relatively to the upstream end portion, and becomes an edge (hereinafter referred to as “Edge 2”) colored in magenta, which is a complementary color of green. The image reading apparatus 100 according to the first embodiment detects a particular image pattern (for example, image pattern including Edge 1 on the upstream side and Edge 2 on the downstream side in the sub-scanning direction) based on the particular color (for example, green) and the complementary color of the particular color depending on the light amount ratio (for example, 1.25) of the particular color to determine the shadows 201 and 202. Edge 1 corresponds to the color edge, and may be detected by the color edge detection unit 307. Edge 2 corresponds to the complementary-color edge, and may be detected by the complementary-color edge detection unit 309. The particular image pattern including Edge 1 and Edge 2 based on the particular color and the complementary color of the particular color depending on the light amount ratio of the particular color is set in the image processing unit 306 in advance. The image reading apparatus 100 detects the shadow area from the read-image of the original, with the result that the shadows generated by step portions of the thick original or a cut-and-paste original can be detected accurately.

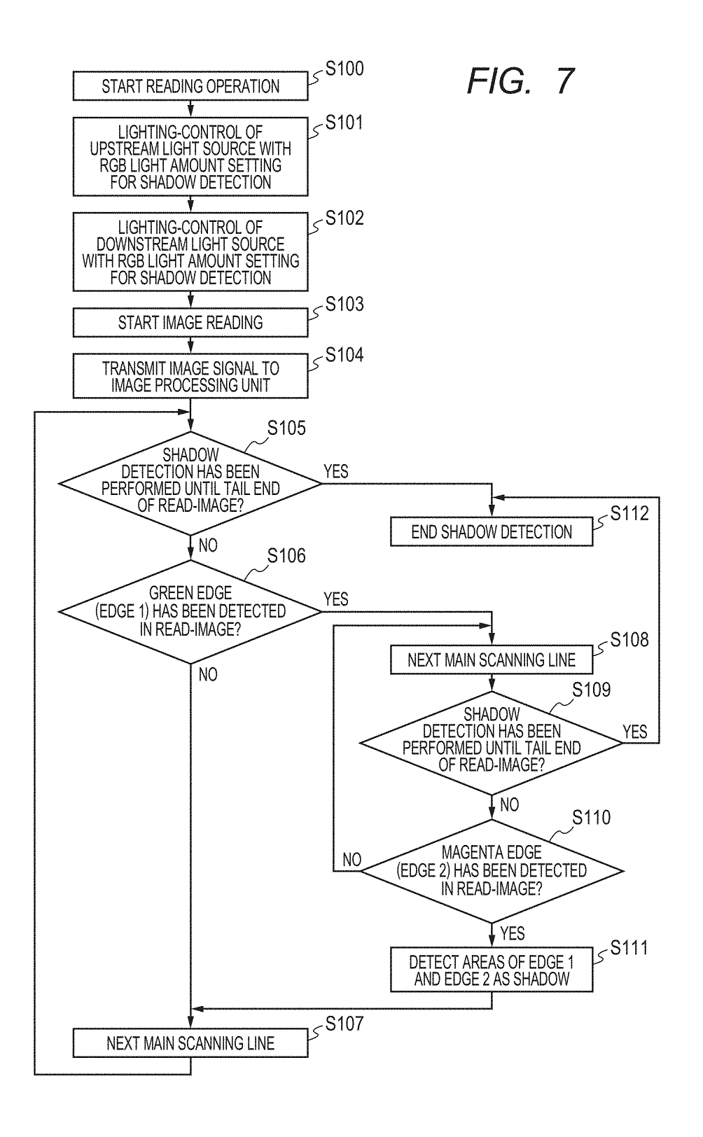

Now, a shadow detection operation in the image reading apparatus 100 is described with reference to FIG. 7. FIG. 7 is a flow chart for illustrating an example of shadow detection operation control in the image reading apparatus 100. Processing in this flow chart is realized by the CPU 301 reading and executing a program stored in the memory 313.

When the user performs an operation of starting scanning via the operation unit 302, the CPU 301 starts the original image reading operation (S100). Then, the CPU 301 lights the upstream light source 104 and the downstream light source 105 under settings in which light amounts are adjusted for detecting the shadow as illustrated in FIG. 4 and FIG. 5 (S101 and S102) to start the image reading by the both sides lighting CIS 103 (S103). Further, the CPU 301 transmits the image signal read by the both sides lighting CIS 103 to the image processing unit 306, and performs control so that the shadow detection operation is executed in the image processing unit 306 (S104).

As illustrated in Steps S105 to S112, the shadow detection operation in the image processing unit 306 starts from a main scanning line at the leading end of the read-image to the tail end of the read-image for each main scanning line, and ends when the shadow detection operation finishes being executed until the tail end. Now, the shadow detection operation is described in detail.

First, the image processing unit 306 sets the main scanning line at the leading end of the read-image as a main scanning line that is a current processing target, and starts processing of Step S105 and subsequent steps. In Step S105, the image processing unit 306 determines whether shadow detection has been performed until a main scanning line at the tail end of the read-image. When it is determined that the shadow detection has not been performed until the main scanning line at the tail end of the read-image yet (NO in S105), the processing proceeds to Step S106.

The image processing unit 306 determines whether the color edge detection unit 307 has succeeded in detecting the edge (Edge 1) colored in green in the main scanning line that is the current processing target (S106). When it is determined that the color edge detection unit 307 has failed in detecting Edge 1 (NO in S106), the image processing unit 306 shifts the processing target to the next main scanning line (S107), and returns the processing to Step S105.

When it is determined that the color edge detection unit 307 has succeeded in detecting Edge 1 (YES in S106), the image processing unit 306 shifts the processing target to the next main scanning line (S108), and the processing proceeds to Step S109. In Step S109, the image processing unit 306 determines whether the shadow detection has been performed until the main scanning line at the tail end of the read-image. When it is determined that the shadow detection has not been performed until the main scanning line at the tail end of the read-image yet (NO in S109), the processing proceeds to Step S110.

In Step S110, the image processing unit 306 determines whether the complementary-color edge detection unit 309 has succeeded in detecting the edge (Edge 2) colored in magenta in the main scanning line that is the current processing target. When it is determined that the complementary-color edge detection unit 309 has failed in detecting Edge 2 (NO in S110), the image processing unit 306 returns the processing to Step S108, and shifts the processing target to the next main scanning line.

When it is determined that the complementary-color edge detection unit 309 has succeeded in detecting Edge 2 (YES in S110), the shadow determination unit 311 determines an area of Edge 1 and an area of Edge 2 as shadows generated in the end portion of the original (S111). Then, the image processing unit 306 shifts the processing target to the next main scanning line (S107), and returns the processing to Step S105.

In the loop of Steps S105 to S111, when the image processing unit 306 determines that the shadow detection has been performed until the main scanning line at the tail end of the read-image (YES in S105 or S109), the shadow detection operation is ended (S112).

The CPU 301 may be configured to control the image processing unit 306 so as to perform processing of enhancing a density contrast on the original image read by the both sides lighting CIS 103. As a result, the shadow detection with higher accuracy can be realized.

In the above-mentioned example, green is set as the particular color, and the light amount ratio of the upstream light source to the downstream light source is set so that the upstream side has the larger light amount only for green. However, the present invention is not limited thereto. Regarding the setting of the particular color for which the light amount ratio of the upstream light source to the downstream light source is set to be different from those of the other colors (in the above-mentioned example, the upstream side is set to have the larger light amount), similar shadow detection can be performed when a color other than green is set as long as the color can be generated by combining the red, green, and blue light sources. In addition, the setting of the light amount ratio is not limited to 1.25. Further, the present invention is not limited to the setting in which the light amount ratio of the upstream light source to the downstream light source is set so that the upstream side has the larger light amount for only the particular color. The setting may be made so that the downstream side has the larger light amount. Even in this case, similar shadow detection can be performed.

Some or all of the functions of the image processing unit 306 may be realized by software. In other words, the CPU 301 may read and execute programs stored in the memory 313 (programs for realizing some or all of the functions of the image processing unit 306 by the CPU 301) to realize some or all of the functions of the image processing unit 306.

As described above, the image reading apparatus 100 controls the light amount ratio of the upstream side to the downstream side for the particular color of the plurality of light sources to read the image data. The image reading apparatus 100 detects a particular image pattern depending on the light amount ratio of the particular color from the read image data. As a result, based on the image data of the original, the shadow generated in the end portion of the original can be detected with high accuracy. Therefore, the shadow generated in the end portion of the original when the image is read from the thick original is read. As a result, the black- or halftone-streaked area generated in the original image can be detected accurately. As a result, the shadow generated in the end portion of the thick original is read, and thus the black- or halftone-streaked portion generated in the original image can be corrected accurately. Therefore, high-quality original read-image in which image degradation is suppressed can be provided.

### Modification Example

In the image reading apparatus 100 according to a modification example of the present invention, in addition to the configuration in the first embodiment, an operation mode for performing correction on a detected shadow area (area of the original image that is determined as being the shadow) may be set via the operation unit 302 (setter), for example. When the operation mode is not set, and when the shadow is detected in the shadow detection operation of FIG. 7 (when there is an area determined as being the shadow in the original image), the CPU 301 serves as an annunciator, which is configured to display a pop-up screen indicating that the shadow has been detected on a display portion (not shown) of the operation unit 302. With this display, the message that the shadow has been detected is announced to an operator. The operator who sees the pop-up announcement performs an operation of giving an instruction to execute correction via the operation unit 302. As a result, the CPU 301 serves as an instruction receiver, which is configured to control the shadow area correction unit 312 of the image processing unit 306 so as to perform the correction on the detected shadow area. A button for giving the instruction to execute the correction may be displayed on the pop-up screen, and the button may be pressed by the operator so that the instruction to execute the correction can be given.

When the operation mode is set, and when the shadow is detected in the shadow detection operation of FIG. 7, the CPU 301 controls the shadow area correction unit 312 of the image processing unit 306 so as to perform the correction on the detected shadow area automatically without the instruction from the operator. As described above with reference to FIG. 2, the shadows are generated in areas adjacent to the leading end and the tail end of the original in a conveyance direction of the original. Therefore, a leading end portion and a tail end portion of the original can be detected by detecting the shadows and determining colors of the shadows. An original area may be determined based on the detection result of the leading end and the tail end.

The image reading apparatus according to the present invention is capable of detecting the black- or halftone-streaked portion generated in the original image accurately by reading the shadow generated in the end portion of the thick original. The image reading apparatus is capable of accurate detection even when originals placed on the original table glass are read in a state in which, under an original, another thick original is overlaid. Moreover, the image reading apparatus is capable of accurate detection even when the original is read in a state in which a thick original is placed alone on the original table glass.

In the above-mentioned embodiment and modification example, there has been described the structure in which the original image is read while the light sources are moved with respect to the original placed on the original table glass. However, the present invention is also applicable to the structure in which the light sources are fixed, and in which the original is moved to read the original image, or to the structure in which the original image is read while both of the original and the light sources are moved. For example, an auto document feeder (ADF) may be provided to convey the original placed on an original tray to a reading position, and the original that is being conveyed may be read using a reading unit, which is fixed to read an image at the reading position. In other words, the present invention is applicable to any structure in which the original image is read while the light sources are moved relatively to the original. In other words, the present invention is applicable to any image reading apparatus including the light sources (in the first embodiment, the upstream light source 104 and the downstream light source 105), each of which is configured to sequentially irradiate the original with light of different colors (in the first embodiment, red, green, and blue), and which are arranged on the upstream side and the downstream side of the image reading position in the moving direction, and the reading unit (in the first embodiment, the both sides lighting CIS 103), which is configured to read the original image while moving the light sources relatively to the original in the sub-scanning direction.

The above-mentioned configuration and details of various kinds of data may be formed of various configurations and details depending on the use and purpose. One embodiment has been described above, but the present invention may be embodied as a system, apparatus, method, program, or storage medium, for example. Specifically, the present invention may be applied to a system formed of a plurality of devices, or to an apparatus formed of one device. All configurations obtained by combining the above-mentioned embodiment and modification example are encompassed by the present invention.

### Other Embodiments

The present invention may be realized by processing of supplying a program for realizing at least one function of the above-mentioned embodiment to a system or apparatus via a network or storage medium, and reading and executing the program by at least one processor in a computer of the system or apparatus. Moreover, the present invention may also be realized by a circuit (for example, ASIC) for realizing at least one function. Moreover, the present invention may be applied to a system formed of a plurality of devices, or to an apparatus formed of one device. The present invention is not limited to the above-mentioned embodiment, and various modifications (including an organic combination of the embodiment and the modification example) may be made thereto based on the spirit of the present invention, and they are not excluded from the scope of the present invention. In other words, all configurations obtained by combining the above-mentioned embodiment and the modification example thereof are encompassed by the present invention.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-113345, filed Jun. 7, 2016, which is hereby incorporated by reference herein in its entirety.

What is claimed is:

1. An image reading apparatus, comprising:
a reader comprising a light source arranged on an upstream side of an image reading position in a moving direction and a light source arranged on a downstream side of the image reading position in the moving direction, each of the light sources configured to sequentially irradiate an original with light of different colors, the reader configured to read an original image at the image reading position while moving each of the light sources relatively to the original in the moving direction;
a controller configured to control the reading of the original image by the reader by setting a light amount ratio of the light source arranged on the upstream side to the light source arranged on the downstream side for a particular color of the different colors to be different from a light amount ratio for another color; and
a detector configured to detect an image pattern of the particular color depending on the light amount ratio from the original image read by the reader.

2. An image reading apparatus according to claim 1, wherein the detector is further configured to detect an image pattern based on a complementary color of the particular color and depending on the light amount ratio.

3. An image reading apparatus according to claim 2, wherein the detector is configured to detect, as the image pattern based on the particular color, a first edge colored in the particular color depending on the light amount ratio from the read original image, and to detect, as the image pattern based on the complementary color, a second edge colored in the complementary color depending on the light amount ratio from the read original image.

4. An image reading apparatus according to claim 1, further comprising a corrector configured to correct an image on an area of the original image corresponding to the image pattern detected by the detector.

5. An image reading apparatus according to claim 4, further comprising a setter configured to set an operation mode for performing the correction,
wherein the corrector is configured to perform the correction when the operation mode is set.

6. An image reading apparatus according to claim 5, further comprising:
an annunciator configured to announce, when the operation mode is not set, and when the image pattern is detected by the detector, to an operator that a shadow generated in an end portion of the original is detected; and
an instruction receiver configured to receive, in response to the announcement by the annunciator, an instruction on whether or not to perform the correction from the operator,
wherein the corrector is configured to perform the correction when the instruction receiver receives an instruction to perform the correction.

7. An image reading apparatus according to claim 1, further comprising an image processor configured to perform enhancement processing for a density contrast on the original image,
wherein the detector is configured to detect the image pattern from the original image on which the enhancement processing has been performed.

8. A method of controlling an image reading apparatus, the image reading apparatus comprising a reader comprising a light source arranged on an upstream side of an image reading position in a moving direction and a light source arranged on a downstream side of the image reading position in the moving direction, each of the light sources configured to sequentially irradiate an original with light of different colors, the reader configured to read an original image while moving each of the light sources relatively to the original in the moving direction,
the method comprising:
controlling the reading of the original image by the reader by setting a light amount ratio of the light source arranged on the upstream side to the light source arranged on the downstream side for a particular color of the different colors to be different from a light amount ratio for another color; and
detecting an image pattern of the particular color depending on the light amount ratio from the original image read by the reader.
